(19) United States
(12) Patent Application Publication
(10) Pub. No.: US 2010/0299669 A1
(43) Pub. Date: Nov. 25, 2010

(54) Generation of a Comparison Task List of Task Items

(75) Inventors: Heather O'Cull, Seattle, WA (US); Charles Hugh Burns, III, Redmond, WA (US); Lei Jiang, Redmond, WA (US)

Correspondence Address: MERCHANT & GOULD (MICROSOFT), P.O. BOX 2903, MINNEAPOLIS, MN, 55402-0903, US

(73) Assignee: MICROSOFT CORPORATION, Redmond, WA (US)

(21) Appl. No.: 12/469,013

(22) Filed: May 20, 2009

(51) Int. Cl. G06F 9/46

(52) U.S. Cl. 718/102

(57) ABSTRACT

A computing system generates and displays a comparison task list that reports differences between a source task list for a project and a modified task list for the project. The comparison task list may enable a user to determine the implications of changes to the project by providing a comparison of the source task list and the modified task list. The computing system generates the comparison task list by generating the comparison task list as a copy of the source task list. The computing system automatically adds each task item in the modified task list that does not have an equivalent task item in the comparison task list to the comparison task list at positions that depend on whether the task items have previously-processed sibling task items in the modified task list. When the computing system has processed each task item in the modified task list, the computing system displays the comparison task list.

### BACKGROUND

In today's business environment, it is important for enterprises to plan their projects such that the enterprises' resources are used effectively. Project planning applications help enterprises plan their projects by helping enterprises conceptualize complex projects as sets of discrete tasks. For example, a project planning application may help an enterprise plan a project of designing a web site. In this example, the project may be conceptualized as a task of identifying needed content, a task of installing and testing back-end software components, a task of designing graphics, a task of testing the web site, and so on. Each task has an anticipated start date, an anticipated end date, and a set of resources. The anticipated start date of a task is the date when the enterprise expects work on the task to begin. The anticipated end date of a task is the date when the enterprise expects work on the task to be complete. The set of resources of a task are resources that the enterprise anticipates using to perform the work of the task. Example types of resources include persons, machines, groups of people, money, and so on. For example, the task of designing graphics may have a start date of May 15, 2009 and an end date of Jun. 1, 2009. In this example, the enterprise may assign a person with graphics design experience to the task of designing graphics and a computer with graphics design software to the task of designing graphics.

In some instances, a task may comprise one or more sub-tasks. For example, a task of installing and testing back-end software components may comprise a task of installing and testing a database system, a task of installing and testing a firewall system, a task of installing and testing a load-balancing system, and so on. When a single task comprises one or more sub-tasks, the single task is a conceptual summary of the set of sub-tasks. In other words, the single task is a concept that represents (i.e., summarizes) the set of sub-tasks. An individual sub-task may comprise one or more sub-sub-tasks, and so on. For example, the task of installing and testing a database system may comprise a task of installing database software, a task of testing the database system under low load, and a task of testing the database system under high load. Thus, the tasks in a project may form a hierarchy of tasks.

Work on some tasks cannot start before work on other tasks finishes. For example, work on the task of testing a web site cannot start before work on the task of installing back end software components is complete. In another example, where the same person must work on both the task of designing graphics and the task of testing the web site, work on the task of testing the web site cannot start before work on the task of designing graphics is complete. Where work on a first task cannot start before work on a second task finishes, the first task and the second task are sequentially dependent.

Some project planning applications use task lists to present tasks in a project. A task list comprises an ordered set of task items. Each of the task items represents a task in the project. Each task item may include a plurality of fields. The plurality of fields in a task item for a task includes an anticipated start date field that specifies a start date of the task, an anticipated end date field that specifies an end date of the task, and so on.

A user is able to edit a project by editing the fields of task items in the task list for the project. For example, the user may edit a start date of a task by editing the values of the anticipated start date field of the task item for the task. Editing values of anticipated start date fields and values of anticipated end date fields of task items may automatically cause a cascade of changes in a project. For example, assume a first task item represents a first task and a second task item represents a second task. In this example, if work on the first task cannot start before work on the second task is complete, and a user edits the value of the anticipated end date field of the second task item, the value of the anticipated start date field and the value of the anticipated end date field of the first task item must also change. In this example, if work on the first task was scheduled to start on April 13 and work on the second task was scheduled to be complete on April 12 and the user edits the value of the anticipated end date field of the second task item to be April 14, then the value of the anticipated start date field of the first task item needs to be automatically updated to be April 15. Such automatic changes can make it difficult for a user to understand the implications of editing values of fields of task items. The problem of understanding the implications of editing a task list may be further complicated when the user adds new task items to the task list and when the user deletes task items from the task list.

### SUMMARY

A computing system generates and displays a comparison task list that reports differences between a source task list for a project and a modified task list for the project. The comparison task list may enable a user to determine the implications of changes to the project by providing a comparison of the source task list and the modified task list. The computing system generates the comparison task list by generating the comparison task list as a copy of the source task list. The computing system automatically adds each task item in the modified task list that does not have an equivalent task item in the comparison task list to the comparison task list at positions that depend on whether the task items have previously-processed sibling task items in the modified task list. When the computing system has processed each task item in the modified task list, the computing system displays the comparison task list.

This summary is provided to introduce a selection of concepts in a simplified form. These concepts are further described below in the Detailed Description. This summary is not intended to identify key features or essential features of the claimed subject matter, nor is this summary intended as an aid in determining the scope of the claimed subject matter.

### BRIEF DESCRIPTION OF THE DRAWINGS

FIG. 1 is a block diagram illustrating an example computing system.

FIG. 2 is a flowchart illustrating an example operation of the computing system to generate and display a comparison task list.

FIG. 3 is a screen illustration showing an example user interface containing a source task list for a project.

FIG. 4 is a screen illustration showing an example user interface containing a modified task list for the project.

FIG. 5 is a screen illustration showing an example user interface containing a comparison task list for the project.

FIG. 6 is a block diagram showing example physical components of an electronic computing device.

### DETAILED DESCRIPTION

As briefly described above, this disclosure describes the generation and display of a comparison task list that reports differences between a source task list for a project and a modified task list for the project. This disclosure describes the generation and display of the comparison task list with reference to a set of figures. It should be appreciated that the figures are provided for explanatory purposes only and are not intended to represent a sole means of implementing the technologies of this disclosure.

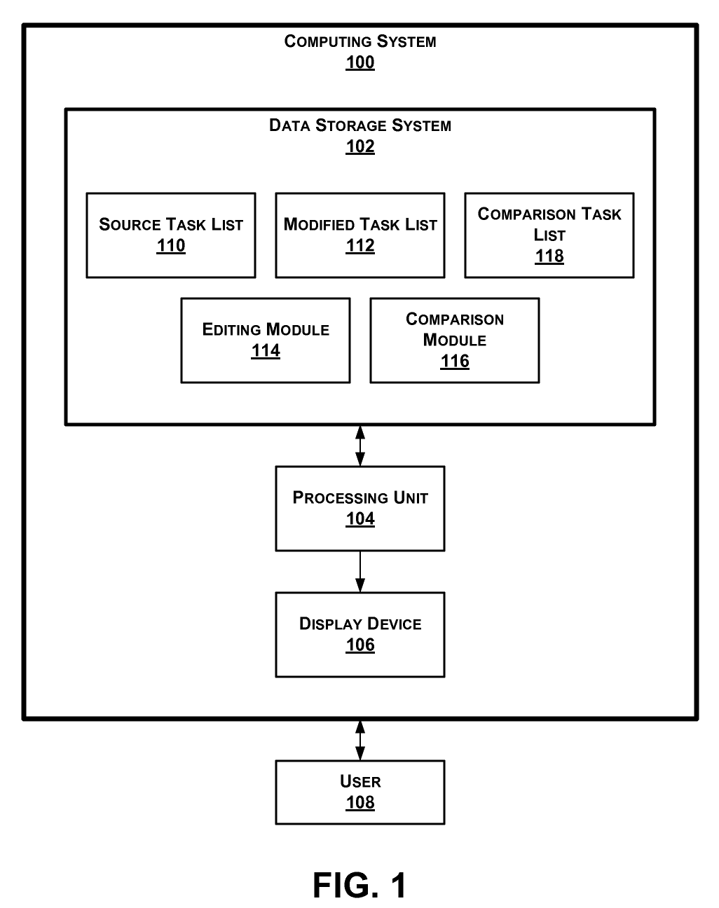

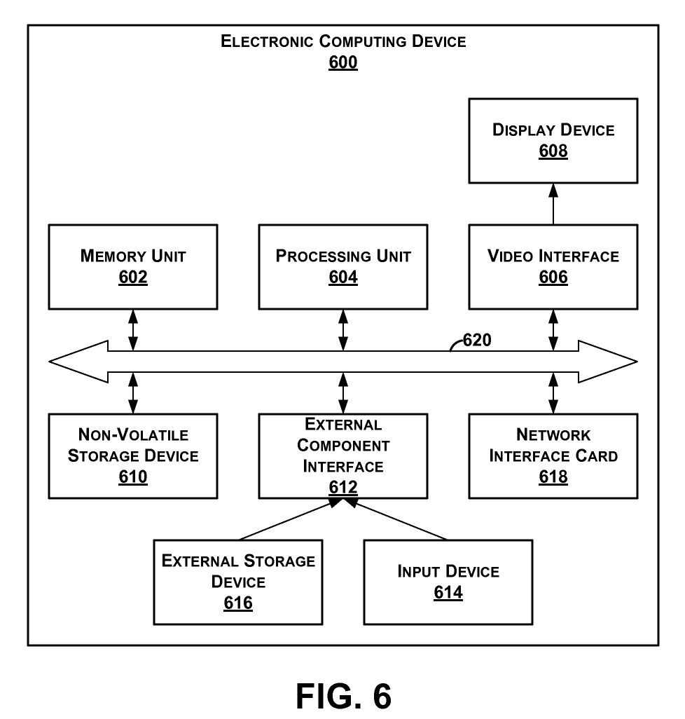

FIG. 1 is a block diagram illustrating an example computing system 100. The computing system 100 is an electronic computing system. As used in this disclosure, an electronic computing system is a set of one or more physical electronic computing devices. An electronic computing device is a physical machine that comprises physical electronic components. Electronic components are physical entities that affect electrons or fields of electrons in a desired manner consistent with the intended function of an electronic computing device. Example types of electronic components include capacitors, resistors, diodes, transistors, and other types of physical entities that affect electrons or fields of electrons in a manner consistent with the intended function of an electronic computing device. An example physical computing device is described below with reference to FIG. 6.

In the example of FIG. 1, the computing system 100 comprises a data storage system 102. The data storage system 102 is a data storage system. As used in this disclosure, a data storage system is a set of one or more physical computer readable data storage media. A computer readable data storage medium is a physical article of manufacture that is capable of storing computer-readable data. Example types of computer readable data storage media include hard disk drives, flash memory units, random access memory (RAM) modules, read-only memory (ROM) modules, CD-ROM discs, Digital Versatile Disc (DVD) ROM discs, BluRay discs, magnetic tape, floppy disks, and other articles of manufacture that are capable of storing computer-readable data.

Furthermore, in the example of FIG. 1, the computing system 100 comprises a processing unit 104. The processing unit 104 is a processing unit. As used in this disclosure, a processing unit is a set of at least one physical integrated circuit that executes software instructions. As used in this disclosure, a software instruction is a data structure that represents an operation of a processing unit. For example, a software instruction may be a data structure comprising an operation code and zero or more operand specifiers. In this example, the operand specifiers may specify registers, memory locations, or literal data. Execution of a software instruction by a processing unit of a computing system causes the computing system to perform the operation represented by the software instruction.

In the example of FIG. 1, the computing system 100 also comprises a display device 106. The display device 106 is a display device. As used in this disclosure, a display device is a physical machine that is capable of displaying images. Example types of display devices include computer monitors, televisions, liquid crystal display (LCD) screens, light-emitting diode (LED) screens, plasma screens, and other types of physical machines that are capable of displaying images.

A user 108, in the example of FIG. 1, interacts with the computing system 100. The user 108 is an individual human being. The user 108 may be using the computing system 100 on behalf of an enterprise. As used in this disclosure, an enterprise is a natural or legal entity. Example types of legal entities include corporations, partnerships, proprietorships, companies, non-profit corporations, foundations, estates, governmental agencies, and other types of legal entities. The user 108 may interact with the computing system 100 in a variety of ways. For example, the user 108 may use an input device, such as a keyboard or mouse, directly connected to the computing system 100 to interact with the computing system 100. In another example, the user 108 may interact with the computing system 100 by interacting with a client computing system (not shown) that communicates with the computing system 100.

In the example of FIG. 1, the data storage system 102 stores a source task list 110 and a modified task list 112. The source task list 110 and the modified task list 112 are a task lists. As used in this disclosure, a task list is a data structure that represents a planned project of an enterprise. A task list representing a planned project of an enterprise comprises an ordered set of task items. As used in this disclosure, a top of a task list is the first task item in the task list and the bottom of the task list is a last item in the task list. Each of the task items represents a different task in the project. Each of the task items is a data structure that represents a task in the planned project. The source task list 110 and the modified task list 112 represent the same planned project of the enterprise. However, the source task list 110 and the modified task list 112 comprise different sets of task items. The modified task list 112 is termed the modified task list because the task items in the modified task list 112 are deemed modified relative to the task items in the source task list 110.

Each task item in the source task list 110 and the modified task list 112 comprises a plurality of fields. Each of the fields describes an aspect of a different task in the project. For example, the plurality of fields may include at least a task name field, an anticipated start date field, an anticipated end date field, a duration field, a creation time field, and a unique identifier field. The task name field of a task item contains text that indicates a name of a task. The anticipated start date field of a task item contains a date that indicates a date when work on a task is expected to start. The anticipated end date field of a task item contains a date that indicates a date when work on a task is expected to be complete. The duration field of a task item contains a value that indicates how much time work on a task is expected to take. The creation time field of a task item contains a time value that indicates the time and date at which the task item was created. The unique identifier field of a task item in a task list contains a unique identifier that is unique among task items in the task list.

In some instances, task items in the task lists, such as the source task list 110 and the modified task list 112, may represent tasks that comprise of one or more sub-tasks. In such instances, the task lists include a task item for each of the sub-tasks. When a single task comprises a set of one or more sub-tasks, the single task is a conceptual summary of the set of sub-tasks. In other words, the single task is a concept that represents (i.e., summarizes) the set of sub-tasks. As used in this disclosure, a first task is a parent of a second task when the first task is a conceptual summary of the second task. Accordingly, a first task item is a parent of a second task item when the first task item represents a first task and the second task item represents a second task and the first task is a parent of the second task. Furthermore, as used in this disclosure, a first task is an immediate parent of a second task when the first task is a conceptual summary of the second task and there are no intervening tasks between the first task and the second task. As used in this disclosure, a first task is an intervening task between a second task and a third task when the first task is a conceptual summary of the third task and the second task is a conceptual summary of the first task. A first task item is an immediate parent of a second task item when the first task item represents a first task and the second task item represents a second task and the first task is an immediate parent of the second task. As used in this disclosure, a first task is a sibling of a second task when the first task and the second task have a shared immediate parent task or when both the first task and the second task do not have a parent task. Accordingly, a first task item is a sibling of a second task item when the first task item represents a first task and the second task item represents a second task and the first task is a sibling of the second task. A first task is a child of a second task when the second task is a conceptual summary of the first task. Accordingly, a first task item is a child of a second task item when the first task item represents a first task and the second task item represents a second task and the first task is a child of the second task.

Task items in a task list are ordered based on the parent-child relationships between task items. In other words, task items are ordered in a task list such that for any task item, all child task items of the task item are ordered in the task list before any non-child task item of the task item. In some example implementations, task items in a task list are secondarily ordered on the anticipated start dates of the sibling task items, while preserving the previously-mentioned ordering based on the parent-child relationships. In other words, in such implementations, for any two task items A and B, where task item A and task item B are siblings, task item A is listed closer to the top of the task list than task item B only if task item A has an earlier anticipated start date than task item B or if task item A has the same anticipated start date as task item B. As used in this disclosure, an initial task item of a task list is a task item that is at the top of (i.e., listed first in) the task list. Furthermore, as used in this disclosure, an initial child task item of a task item in a task list is a task item that is listed first in the task list among all child task items of the task item

The data storage system 102 also stores an editing module 114. In the example of FIG. 1, the editing module 114 comprises a set of software instructions that, when executed by the processing unit 104, cause the computing system 100 to enable the user 108 to view and edit task lists. For ease of explanation, this disclosure discusses the editing module 114 as performing various activities. It should be appreciated that, unless otherwise indicated, discussion of the editing module 114 performing such activities implies the processing unit 104 executing software instructions of the editing module 114 and thereby causing the computing system 100 to perform the various activities.

Furthermore, the data storage system 102 stores a comparison module 116. In the example of FIG. 1, the comparison module 116 comprises a set of software instructions that, when executed by the processing unit 104, cause the computing system 100 to generate and display a comparison task list that reports differences between the source task list 110 and the modified task list 112. For ease of explanation, this disclosure discusses the comparison module 116 as performing various activities. It should be appreciated that, unless otherwise indicated, discussion of the comparison module 116 performing such activities implies the processing unit 104 executing instructions of the comparison module 116 and thereby causing the computing system 100 to perform the various activities.

As mentioned above, the editing module 114 enables the user 108 to generate and edit task lists. To enable the user 108 to generate task lists, the editing module 114 displays a user interface on the display device 106. In one example implementation, the user interface contains a table having a row for each task item in a task list. In this example implementation, the table has a column for each field of the task items. For instance, the table may have a column for the task name field, a column for the anticipated start date field, a column for the anticipated end date field, a column for the anticipated duration field, and so on. To visually indicate a parent/child relationship between two task items in the table, the task name of the child task item is indented relative to the task name of the parent task item.

The editing module 114 enables the user 108 to change the values of fields of task items in a task list. For example, the editing module 114 may enable the user 108 to provide editing input to the editing module 114. The editing input may indicate that the user wishes to add a task item, delete a task item, edit a value specified by a field of a task item or otherwise edit a task list. In response to receiving the editing input, the editing module 114 updates the task list without saving the task list. In this example, the editing input may indicate that the user wishes to change the anticipated start date of a task item. In one example implementation, when the user 108 provides editing input that indicates that the user wishes to change an anticipated start date or an anticipated end date of a task item, the editing module 114 automatically updates the anticipated start dates and/or anticipated end dates of sequentially dependent task items. As used in this disclosure, a first task item is sequentially dependent on a second task item when the first task item represents a first task, the second task item represents a second task, and work on the first task that cannot start until work on the second task is complete. The editing module 114 also enables the user 108 to add task items to a task list or delete task items from the task list. The editing module 114 enables the user 108 to add task items as parents or children of other task items in the task list.

After the user 108 is finished editing a task list, the editing module 114 saves the task list. In some instances, the editing module 114 saves the task list as a separate task list. For instance, the editing module 114 saves the task list as a separate task list when the user 108 sends a “save as” command the editing module 114. In this way, the user 108 can cause the editing module 114 to generate the modified task list 112 from the source task list 110.

Subsequently, the user 108 may wish to compare two task lists to determine how the two task lists differ. For example, the user 108 may wish to compare the source task list 110 to the modified task list 112 to determine how the source task list 110 differs from the modified task list 112. In one example implementation, the editing module 114 includes a compare command in the user interface. When the user 108 selects the compare command, the editing module 114, in response, invokes the comparison module 116, thereby initiating a comparison of the source task list 110 and the modified task list 112.

When invoked, the comparison module 116 generates a comparison task list 118. The comparison task list 118 is a data structure that reports the differences between the source task list 110 and the modified task list 112. In one example implementation, the comparison task list 118 comprises a set of task items. The set of task items in the comparison task list 118 includes each task item in the source task list 110 and the modified task list 112. The set of task items in the comparison task list 118 also includes each of the fields of the task items in the source task list 110 and the modified task list 112. In addition, the set of task items in the comparison task list 118 include additional fields. The additional fields indicate differences between the source task list 110 and the modified task list 112. For example, the addition fields may include a status field. In this example, the status field of a task item in the comparison task list 118 indicates whether the task item is in both the source task list 110 and the modified task list 112, whether the task item is in source task list 110 but not the modified task list 112, or whether the task item is not in the source task list 110 but is in the modified task list 112. In another example, the additional field may include fields that specify previous values of fields. In this example, the additional fields may include a previous anticipated start date field. In this example, when a task item is the source task list 110 and the modified task list 112, but the anticipated start date of the task item is different in the source task list 110 and the modified task list 112, the anticipated start date field of the task item in the comparison task list 118 indicates the anticipated start date of the task item in the modified task list 112 and the previous start date field of the task item indicates the anticipated start date of the task item in the source task list 110. The comparison task list 118 may include similar previous value fields for anticipated end date fields, anticipated duration fields, and so on. In a third example, the comparison task list 118 may include one or more additional fields indicating differences between the values of fields in the source task list 110 and the modified task list 112. For instance, the comparison task list 118 may include a duration difference field that indicates a difference between the anticipated duration of a task item in the source task list 110 and the anticipated duration of an equivalent task item in the modified task list 112.

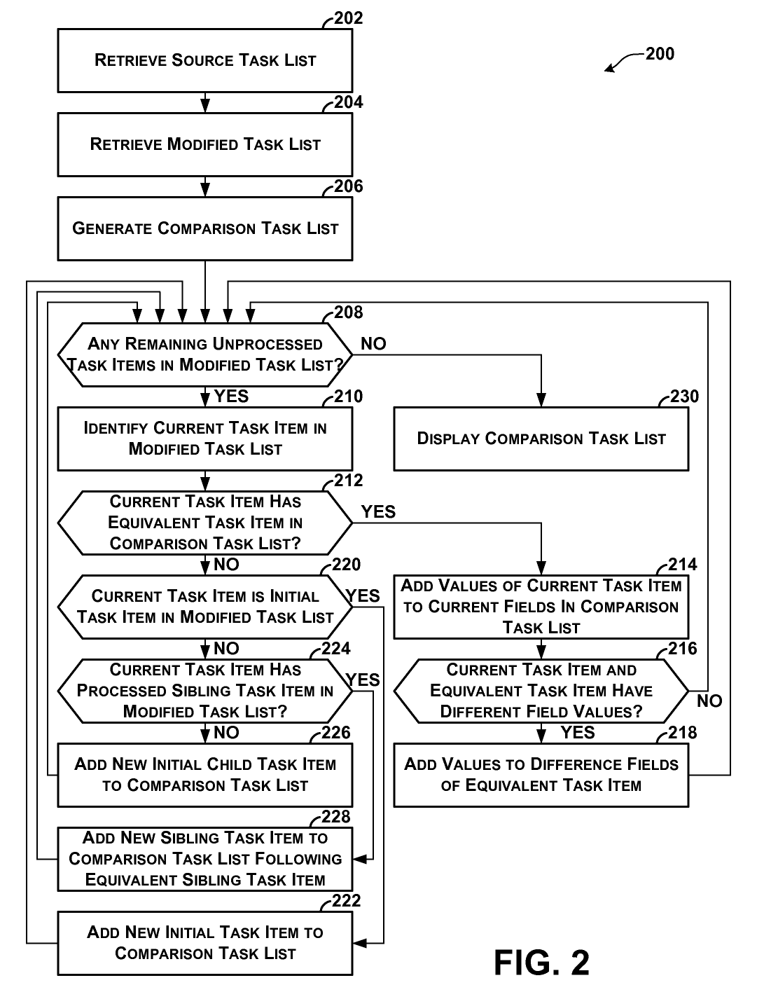

As explained in detail below with reference to FIG. 2, the comparison module 116 initially generates the comparison task list 118 from the source task list 110. The comparison task list 118 contains a different task item for each task item in the source task list 110. Each of the task items in the comparison task list 118 comprises a plurality of current value fields and a plurality of previous value fields. The previous value fields of the task items in the comparison task list 118 specify values specified by fields of task items in the source task list 110. Furthermore, in some implementations, each of the task items in the comparison task list 118 includes one or more difference fields. The difference fields contain values indicating differences between values indicated by previous value fields and values indicated by corresponding current value fields.

After generating the comparison task list 118, the comparison module 116 automatically determines whether there are any unprocessed task items in the modified task list 112. While there are unprocessed task items in the modified task list 112, the comparison module 116 automatically identifies a current task item in the modified task list 112. The current task item is an initial unprocessed task item in the modified task list 112. Next, the comparison module 116 automatically determines whether the current task item has an equivalent task item in the comparison task list 118.

When the current task item has an equivalent task item in the comparison task list 118, the comparison module 116 copies values of fields of the current task item to corresponding current value fields of the equivalent task item. The comparison module 116 then automatically determines whether the current task item and the equivalent task item have different field values. When the current task item and the equivalent task item have different field values, the comparison module 116 adds values to difference fields of the equivalent task item. When the current task item does not have an equivalent task item in the comparison task list 118, the comparison module 116 automatically determines whether the current task item is an initial task item in the modified task list 112.

When the current task item is the initial task item in the modified task list, the comparison module 116 automatically adds a new initial task item to the comparison task list. The new initial task item is an initial task item in the comparison task list 118. For each of the fields of the current task item, the new initial task item has a current value field and a previous value field. The current value fields of the new initial task item specify the values specified by corresponding ones of the fields of the current task item. The previous value fields and difference fields of the new initial task item do not contain values.

When the current task item is not the initial task item in the modified task list, the comparison module 116 automatically determines whether the current task item has a previously-processed sibling task item in the modified task list 112. When the current task item has a previously-processed sibling task item in the modified task list 112, the comparison module 116 automatically adds a new sibling task item to the comparison task list 118. The new sibling task item follows a task item in the comparison task list that is equivalent to the previously-processed sibling task item. For each of the fields of the current task item, the new sibling task item has a current value field and a previous value field. The current value fields of the new sibling task item specify values specified by corresponding ones of the fields of the current task item.

When the current task items does not have a previously processed sibling task item in the modified task list 112, the comparison module 116 automatically adds a new child task item to the comparison task list 118. The new child task item is an initial child task item of a task item in the comparison task list that is equivalent to the parent task item of the current task item. For each of the fields of the current task item, the new child task item has a current value field and a previous value field. The current value fields of the new child task item specify the values specified by corresponding ones of the fields of the current task item. The equivalent parent task item is a task item in the comparison task list 118 that is equivalent to a parent task item of the current task item. When there are no unprocessed task items in the modified task list 112, the comparison module 116 has finished generating the comparison task list 118

After the comparison module 116 generates the comparison task list 118, the comparison module 116 stores the comparison task list 118 in the data storage system 102. Furthermore, after the comparison module 116 generates the comparison task list 118, the editing module 114 displays the comparison task list 118 on the display device 106. The editing module 114 may display the comparison task list 118 in a variety of ways. For example, the editing module 114 may display the comparison task list 118 as a table. In this example, the editing module 114 may display the comparison task list 118 as a table having a row for each task item in the comparison task list 118. Furthermore, in this example, the table has a column for each field of the task items in the comparison task list 118. By presenting the comparison task list 118 in this way, the user 108 may be able to easily identify the differences between the source task list 110 and the modified task list 112.

FIG. 2 is a flowchart illustrating an example operation 200 of the computing system 100 to generate and display the comparison task list 118. It should be appreciated that the operation 200 is merely one example operation of the computing system 100. It should be appreciated that other operations of the computing system 100 to generate and display the comparison task list 118 are possible. Other operations of the computing system 100 to generate and display the comparison task list 118 may include more or fewer steps. Furthermore, other operations of the computing system 100 to generate and display the comparison task list 118 may include the steps of operation 200 in a different order.

Initially, the comparison module 116 retrieves the source task list 110 from the data storage system 102 (202). In addition, the comparison module 116 retrieves the modified task list 112 from the data storage system 102 (204). The comparison module 116 may receive the source task list 110 and the modified task list 112 in a variety of ways. For example, the comparison module 116 may retrieve the source task list 110 when the user 108 opens the source task list 110 in the editing module 114. In this example, the comparison module 116 may subsequently retrieve the modified task list 112 when the user 108 instructs the editing module 114 to compare the source task list 110 to the modified task list 112.

After receiving the source task list 110 and the modified task list 112, the comparison module 116 generates the comparison task list 118 by copying the source task list 110 (206). In one example implementation, the comparison task list 118 starts as an empty list containing no task items. The comparison module 116 creates a new task item in the comparison task list 118 for each task item in the source task list 110. Each task item in the comparison task list 118 has a current value field, a previous value field, and a difference field for each field of the task items in the source task list 110. The comparison module 116 copies the values of each field of each task item in the source task list 110 into corresponding ones of the previous value fields of the comparison task list 118. When the comparison module 116 copies each task item in the source task list 110 into the comparison task list 118, the comparison module 116 preserves the order of the task items in the source task list 110 in the comparison task list 118.

When the comparison module 116 has generated the comparison task list 118, the comparison module 116 determines whether there are any unprocessed task items in the modified task list 112 (208). A task item in the modified task list 112 is an unprocessed task item when the task item has not yet been the current task item of the operation 200.

In response to determining that there are one or more unprocessed task items in the modified task list 112, the comparison module 116 identifies a new current task item in the modified task list 112 (210). The new current task item in the modified task list 112 is the unprocessed task item in the modified task list 112 that is closest to the top of the modified task list 112. The comparison module 116 may identify the new current task item in a variety of ways. For example, the comparison module 116 may maintain a pointer that indicates the current task item. In this example, the comparison module 116 may identify the current task item in the modified task list 112 by advancing the pointer to indicate a next task item in the modified task list 112.

After identifying the current task item, the comparison module 116 determines whether the current task item has an equivalent task item in the comparison task list 118 (212). As used in this disclosure a first task item is equivalent to a second task item if the first task item and the second task item represent the same task. The comparison module 116 may determine whether the current task item has an equivalent task item in the comparison task list 118 in a variety of ways. For example, the comparison module 116 may not be able to rely on the task name fields of task items to determine whether the task items are equivalent because the users are able to edit the task name fields of task items. Furthermore, in this example, the comparison module 116 may not be able to rely on the unique identifier field of task items to determine whether the task items are equivalent because two separate computing devices may have added non-equivalent task items to the source task list 110 and the modified task list 112 and that the two computing devices assigned the same unique identifier to the non-equivalent task items. In other words, the two computing devices could only ensure that the unique identifiers specified by the unique identifier fields were unique among the task items in their own copies of the tasks lists, not all possible copies of the task list. Consequently, in this example, the comparison module 116 may determine that two task items are equivalent when the unique identifier field of a first task item specifies a unique identifier that is the same as a unique identifier specified by a unique identifier field of a second task item and when the creation time field of the first task item specifies a time value that is the same as a time value specified by the creation time field of the second task item. The comparison module 116 uses the creation time field because the chances of two separate computing devices creating two non-equivalent task items with the same unique identifier at the same exact time are very small.

If the current task item does have an equivalent task item in the comparison task list 118, the comparison module 116 adds values of fields of the current task item to current value fields of the equivalent task item (214). The current value fields of the equivalent task item are fields designed to contain the values of fields of the current task item. For example, if the time value of the anticipated start date field of the current task item is Apr. 10, 2009, the comparison module 116 adds the time value Apr. 10, 2009 to a current start date field in the equivalent task item.

Next, the comparison module 116 determines whether the current task item and the equivalent task item have different field values (216). The current task item and the equivalent task item have different field values when any of the fields of the current task item has a different value from a corresponding previous value field of the equivalent task item. A field of a first task item corresponds to a field of a second task item when the field of the first task item describes the same aspect of a task as the field of the second task item. For example, if the task name field of the current task item specifies the task name “Install back-end software” and the previous name field of the equivalent task item specifies the task name “Install server software,” the current task item and the equivalent task item have different field values. If the comparison module 116 determines that the current task item and the equivalent task item do not have different field values (“NO” of 216), the comparison module 116 loops back and again determines whether there are any remaining unprocessed task items in the modified task list 112 (208).

On the other hand, if the comparison module 116 determines that the current task item and the equivalent task item have different field values (“YES” of 216), the comparison module 116 adds, for each field of the current task item specifying a different value than a corresponding previous value field in the equivalent task item, a value to a difference field of the equivalent task item in the comparison task list 118 (218). A difference field of a task item is a field containing a value that indicates a difference between a value specified by a field of the task item in the source task list 110 and a value specified by a corresponding previous value field of an equivalent task item in the modified task list 112. For example, if the time value specified by the anticipated start date field of a task item in the source task list 110 is Apr. 10, 2009 and the time value specified by the previous anticipated start date field of an equivalent task item in the modified task list 112 is Apr. 12, 2009, the comparison module 116 adds the value “2 days” to a difference field of the equivalent task item in the comparison task list 118. After adding the values to difference fields of the equivalent task item, the comparison module 116 loops back and again determines whether there are any remaining unprocessed task items in the modified task list 112 (208).

If the comparison module 116 determines that the current task item does not have an equivalent task item in the comparison task list 118 (“NO” of 212), the comparison module 116 determines whether the current task item is the initial task item in the modified task list 112 (220). As discussed above, the initial task item of a task list is a task item that is at the top of the task list. If the comparison module 116 determines that the current task item is the initial task item in the modified task list 112 (“YES” of 220), the comparison module 116 adds a new initial task item to the comparison task list 118 (222). The new initial task item is the new initial task item of the comparison task list. The current value fields of the new initial task item specifies the values specified by corresponding ones of the fields of the current task item After adding the new initial task item to the comparison task list 118 as the initial task item of the comparison task list 118, the comparison module 116 loops back and again determines whether there are any remaining unprocessed task items in the modified task list (208).

On the other hand, if the current task item is not the initial task item in the modified task list 112 (“NO” of 220), the comparison module 116 determines whether the current task item has a previously-processed sibling task item in the modified task list 112 (224). A first task item is previously-processed sibling task item of a second task item when the first task item is a sibling task item of the second task item and the first task item is closer to the top of the task list than the second task item.

If the comparison module 116 determines that the current task item does not have a previously-processed sibling task item in the modified task list 112 (“NO” of 224), the comparison module 116 adds a new child task item to the comparison task list 118 (226). The new child task item is the initial child task item of a task item in the comparison task list that is equivalent to the parent task item of the current task item. The current value fields of the new child task item specify the values of corresponding ones of the fields of the current task item. After the comparison module 116 adds the initial child task item to the comparison task list 118 as the initial child task item of the equivalent parent task item in the comparison task list 118, the comparison module 116 loops back and again determines whether there are any remaining unprocessed task items in the modified task list 112 (208).

If the comparison module 116 determines that the current task item has a previously-processed sibling task item in the modified task list 112 (“YES” of 224), the comparison module 116 adds a new sibling task item to the comparison task list 118 (228). The new sibling task item follows a task item in the comparison task list 118 that is equivalent to the previously-processed sibling task item in the modified list 112. The current value fields of the new sibling task item specify the values specified by corresponding ones of the fields of the current task item. After the comparison module 116 adds the new sibling task item to the comparison task list 118, the comparison module 116 loops back and again determines whether there are any remaining unprocessed task items in the modified task list 112 (208).

If there are no remaining unprocessed task items in the modified task list 112 (“NO” of 208), the editing module 114 displays the comparison task list 118 (230). As described above, the editing module 114 may display the comparison task list 118 in a user interface on the display device 106 as a table comprising a row for each task item in the comparison task list 118 and a column for each field of the task items in the comparison task list 118.

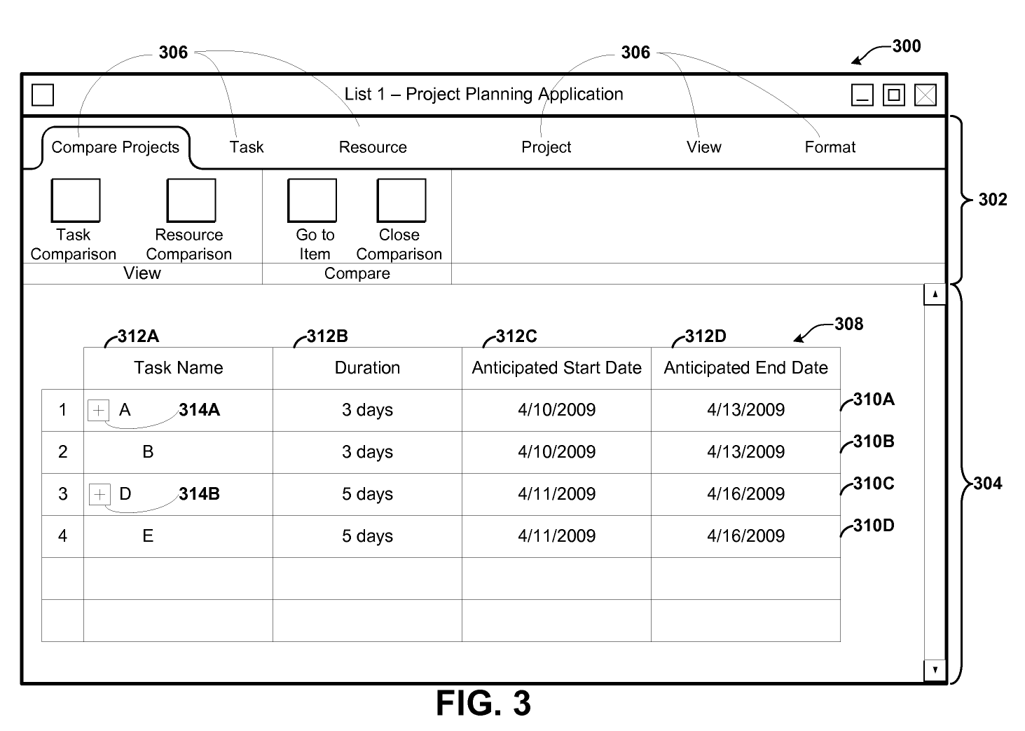

FIG. 3 is a screen illustration showing an example user interface 300 containing a source task list for a project. It should be appreciated that the user interface 300 is provided for purposes of explanation only and is not intended to represent a sole user interface that can be used in connection with the generation and display of a comparison task list that reports differences between a source task list and a modified task list. For purposes of explanation, this disclosure assumes that the user interface 300 contains the source task list 110.

As illustrated in the example of FIG. 3, the user interface 300 comprises a control area 302 and a task list area 304. The control area 302 comprises a control ribbon having a plurality of tabs 306. Each of the tabs 306 contains user-selectable controls. However, only the controls of a selected one of the tabs 306 are shown at any given time. In the example of FIG. 3, the “Compare Projects” tab is the selected one of the tabs 306. As illustrated in the example of FIG. 3, the “Compare Projects” tab includes a “Task Comparison” control, a “Resource Comparison” control, a “Go to Item” control, and a “Close Comparison” control.

The task list area 304 includes a table 308 having rows 310A-310D (collectively, “rows 310”) and columns 312A-312D (collectively, “columns 312”). Each of the rows 310 is associated with a different task item in the source task list 110. Each of the columns 312 is associated with a different field of the task items in the source task list 110. In the example of FIG. 3, the table 308 has column 312A is associated with the task name field of the task items, column 312B is associated with the duration field of the task items, column 312C is associated with the anticipated start date field of the task items, and column 312D is associated with the anticipated end date of the task items. It should be appreciated that other example tables may include more or fewer columns.

In the example of FIG. 3, the task name “B” of the task item associated with row 310B is indented relative to the task name “A” of the task item associated with row 310A. For ease of explanation, this disclosure refers to task items in the table 308 by the task names specified by the task name fields of the task items. Indentation of the task name of the task item “B” relative to the task name of the task item “A” indicates that the task item “B” is a child of the task item “A.” Similarly, the task name of the task item “E” is indented relative to the task name of the task item “D.” This indicates that the task item “E” is a child of the task item “D.” Furthermore, the task item “A” and the task item “D” are sibling task items because both the task item “A” and the task item “D” represent tasks that do not have parent tasks. The task item “B” and the task item “E” are not sibling task items because the task item “B” and the task item “E” do not represent tasks that have no parent tasks and because the task item “B” and the task item “E” do not represents tasks that have a shared immediate parent task.

As illustrated in the example of FIG. 3, expand/collapse controls 314A and 314B (collectively, “expand/collapse controls 314”) are positioned in the task name fields of each task item having one or more child task items (i.e., the task “A” and the task “D”). When the user 108 selects an expand/collapse control in the task name field of a task item when the child task items of the task item are hidden, the computing system 100 causes the user interface 300 to display the child task items of the task item in the table 308. When the user 108 selects an expand/collapse control in the task name field of a task item when the child task items of the task item are visible, the computing system 100 causes the user interface 300 not to display the child task items of the task item in the table 308. For example, if the user 108 were to select the expand/collapse control 314B when the task item “E” is shown, the computing system 100 causes the user interface 300 to hide the task item “E”.

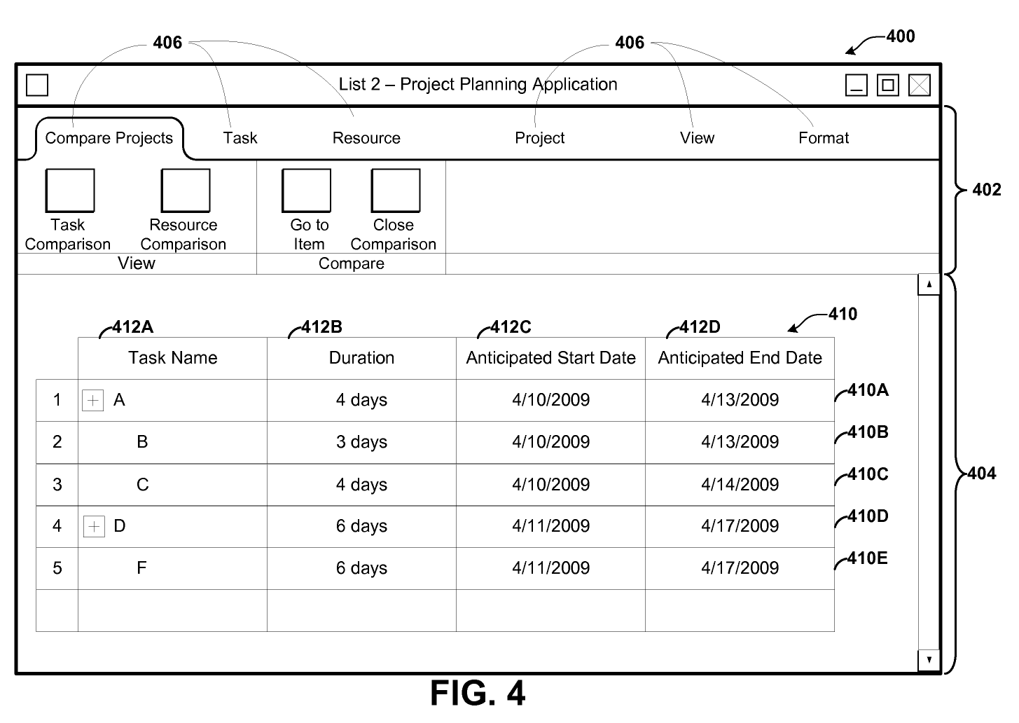

FIG. 4 is a screen illustration showing an example user interface 400 containing a modified task list for the project. It should be appreciated that the user interface 400 is provided for purposes of explanation only and is not intended to represent a sole user interface that can be used in connection with the generation and display of a comparison task list that reports differences between a source task list and a modified task list. For purposes of explanation, this disclosure assumes that the user interface 400 contains the modified task list 112.

The user interface 400 is similar to the user interface 300 illustrated in FIG. 3. The user interface 400 contains a control area 402 and a task list area 404. The control area 402 is similar to the control area 302. Like the control area 302, the control area 402 contains a control ribbon having a plurality of tabs 406. The task list area 404 contains a table 410 similar to the table 310 in FIG. 3. The table 410 has rows 410A-D (collectively, “rows 410”) and columns 412A-E (collectively, “columns 412”).

The table 410 differs from the table 310 in that the user 108 has added a task item “C” to the table 410. The task item “C” appears in the table 410 as the third task item. The task item “C” is a child of the task item “A,” as indicated by the task name of the task item “C” being indented relative to the task name of the task item “A.” The task item “C” has an anticipated start date field of Apr. 10, 2009 and an anticipated end date field of Apr. 14, 2009. Because the task item “A” is a conceptual summary of its child task items “B” and “C,” the anticipated end date field of the task item “A” has been automatically updated to indicate that the anticipated end date of the task item “A” is Apr. 14, 2009 instead of Apr. 13, 2009 and the anticipated duration of the task item “A” is four days instead of three days.

Furthermore, the user has deleted the task item “E” and replaced the task item “E” with a task item “F.” The task item “F” has a duration of six days, an anticipated start date of Apr. 11, 2009, and an anticipated end date of Apr. 17, 2009. Accordingly, the duration fields of the task item “D” have been automatically modified to indicate an anticipated duration of six days instead of five days. The anticipated end date field of the task item “D” has also been automatically modified to indicate an anticipated end date of Apr. 17, 2009 instead of Apr. 16, 2009.

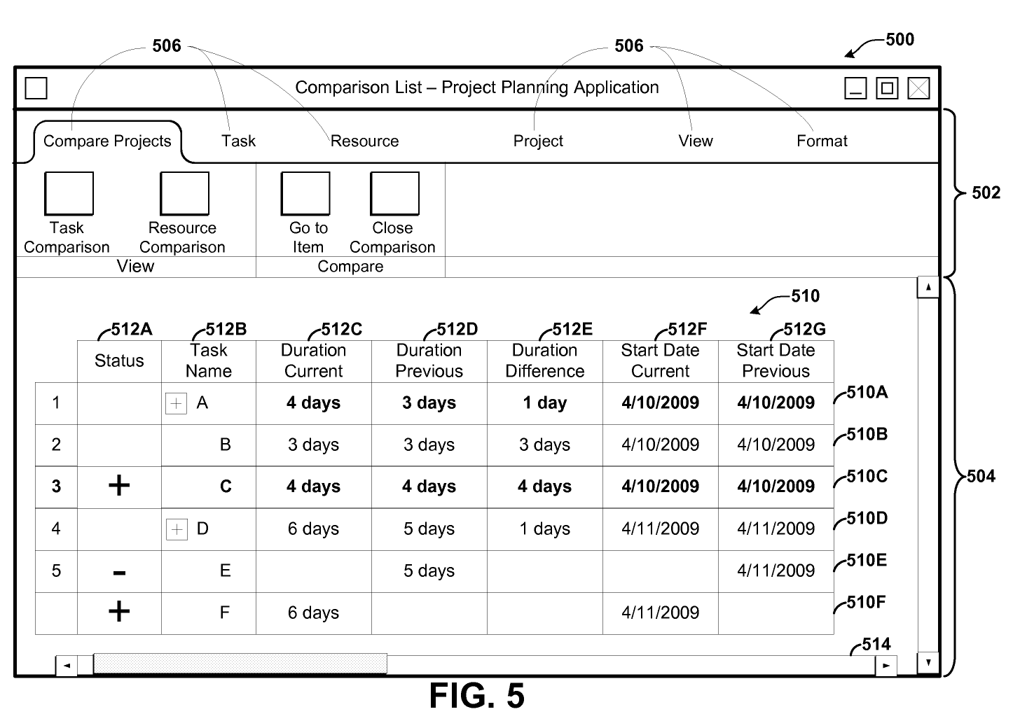

FIG. 5 is a screen illustration showing an example user interface 500 containing a comparison task list for the project. It should be appreciated that the user interface 500 is provided for purposes of explanation only and is not intended to represent a sole user interface that can be used in connection with the generation and display of a comparison task list that reports differences between a source task list and a modified task list. For purposes of explanation, this disclosure assumes that the user interface 500 contains the comparison task list 118.

As illustrated in the example of FIG. 5, the user interface 500 is similar to the user interface 300 illustrated in FIG. 3 and the user interface 400 illustrated in FIG. 4. The user interface 500 includes a control area 502 and a task list area 504. The control area 502 is similar to the control area 302. Like the control area 302, the control area 502 contains a control ribbon having a plurality of tabs 506. The task list area 504 contains a table 510 similar to the table 310 in FIG. 3. The table 510 has rows 510A-510F (collectively, “rows 510”) and columns 512A-512G (collectively, “columns 512”). Values in cells of the table 510 report differences between the source task list 110 as shown in FIG. 3 and the modified task list 112 as shown in FIG. 4.

The columns 512 include a “Status” column 512A. The “Status” column 512A include status indicators that indicate whether a task item is in both the source task list 110 and the modified task list 112, whether the task item is in the source task list 110 but not the modified task list 112, or whether the task is in the modified task list 112 but not the source task list 110. In the example of FIG. 5, the “Status” column 512A does not show a status indicator for a task item when the task item is in both the source task list 110 and the modified task list 112. In addition, in the example of FIG. 5, the “Status” column 512A includes a “−” mark when the task item is in the source task list 110 but not in the modified task list 112. Furthermore, in the example of FIG. 5, the “Status” column 512A includes a “+” mark when the task item is in the modified task list 112 but not in the source task list 110. It should be appreciate that in other implementations other status indicators may be used to indicate the status of task items.

The columns 512 include a column for each current value field of task items in the comparison task list 118. The columns for the current values fields contain the values specified by the current value fields of the task items in the comparison task list 118. In the example of FIG. 5, column 512C and column 512F are columns for current value fields of task items in the comparison task list 118. Furthermore, the columns 512 include a column for each previous value field of task items in the comparison task list. The columns for the previous value fields contain the values specified by the previous value fields of task items in the comparison task list 118. In the example of FIG. 5, column 512D and column 512G are columns for the previous value fields of task items in the comparison task list. The columns 512 also include column for each difference field of task items in the comparison task list 118. The difference for the difference fields contain values specified by the difference fields of task items in the comparison task list 118. In the example of FIG. 5, column 512D is a column for a different field of task items in the comparison task list 118. It should be noted that the table 510 may include additional columns that are not shown in the example of FIG. 5 due to space constraints of the user interface 500. However, the user 108 is able to use a horizontal scrolling control 514 to scroll the table 510 such that the computing system 100 displays additional columns in the user interface 500.

FIG. 6 is a block diagram illustrating example physical components of an electronic computing device 600. As illustrated in the example of FIG. 6, the electronic computing device 600 comprises a memory unit 602. The memory unit 602 is a computer-readable data storage medium capable of storing data and/or instructions. The memory unit 602 may be a variety of different types of computer-readable storage media including, but not limited to, dynamic random access memory (DRAM), double data rate synchronous dynamic random access memory (DDR SDRAM), reduced latency DRAM, DDR2 SDRAM, DDR3 SDRAM, Rambus RAM, or other types of computer-readable storage media.

In addition, the electronic computing device 600 comprises a processing unit 604. As mentioned above, a processing unit is a set of one or more physical electronic integrated circuits that are capable of executing instructions. In a first example, the processing unit 604 may execute software instructions that cause the electronic computing device 600 to provide specific functionality. In this first example, the processing unit 604 may be implemented as one or more processing cores and/or as one or more separate microprocessors. For instance, in this first example, the processing unit 604 may be implemented as one or more Intel Core 2 microprocessors. The processing unit 604 may be capable of executing instructions in an instruction set, such as the x86 instruction set, the POWER instruction set, a RISC instruction set, the SPARC instruction set, the IA-64 instruction set, the MIPS instruction set, or another instruction set. In a second example, the processing unit 604 may be implemented as an ASIC that provides specific functionality. In a third example, the processing unit 604 may provide specific functionality by using an ASIC and by executing software instructions.

The electronic computing device 600 also comprises a video interface 606. The video interface 606 enables the electronic computing device 600 to output video information to a display device 608. The display device 608 may be a variety of different types of display devices. For instance, the display device 608 may be a cathode-ray tube display, an LCD display panel, a plasma screen display panel, a touch-sensitive display panel, a LED array, or another type of display device.

In addition, the electronic computing device 600 includes a non-volatile storage device 610. The non-volatile storage device 610 is a computer-readable data storage medium that is capable of storing data and/or instructions. The non-volatile storage device 610 may be a variety of different types of non-volatile storage devices. For example, the non-volatile storage device 610 may be one or more hard disk drives, magnetic tape drives, CD-ROM drives, DVD-ROM drives, Blu-Ray disc drives, or other types of non-volatile storage devices.

The electronic computing device 600 also includes an external component interface 612 that enables the electronic computing device 600 to communicate with external components. As illustrated in the example of FIG. 6, the external component interface 612 enables the electronic computing device 600 to communicate with an input device 614 and an external storage device 616. In one implementation of the electronic computing device 600, the external component interface 612 is a Universal Serial Bus (USB) interface. In other implementations of the electronic computing device 600, the electronic computing device 600 may include another type of interface that enables the electronic computing device 600 to communicate with input devices and/or output devices. For instance, the electronic computing device 600 may include a PS/2 interface. The input device 614 may be a variety of different types of devices including, but not limited to, keyboards, mice, trackballs, stylus input devices, touch pads, touch-sensitive display screens, or other types of input devices. The external storage device 616 may be a variety of different types of computer-readable data storage media including magnetic tape, flash memory modules, magnetic disk drives, optical disc drives, and other computer-readable data storage media.

In addition, the electronic computing device 600 includes a network interface card 618 that enables the electronic computing device 600 to send data to and receive data from an electronic communication network. The network interface card 618 may be a variety of different types of network interface. For example, the network interface card 618 may be an Ethernet interface, a token-ring network interface, a fiber optic network interface, a wireless network interface (e.g., WiFi, WiMax, etc.), or another type of network interface.

The electronic computing device 600 also includes a communications medium 620. The communications medium 620 facilitates communication among the various components of the electronic computing device 600. The communications medium 620 may comprise one or more different types of communications media including, but not limited to, a PCI bus, a PCI Express bus, an accelerated graphics port (AGP) bus, an Infiniband interconnect, a serial Advanced Technology Attachment (ATA) interconnect, a parallel ATA interconnect, a Fiber Channel interconnect, a USB bus, a Small Computer System Interface (SCSI) interface, or another type of communications medium.

The electronic computing device 600 includes several computer-readable data storage media (i.e., the memory unit 602, the non-volatile storage device 610, and the external storage device 616). Together, these computer-readable storage media may constitute a single data storage system (e.g., the data storage system 102). As discussed above, a data storage system is a set of one or more computer-readable data storage mediums. This data storage system may store instructions executable by the processing unit 604. Activities described in the above description may result from the execution of the instructions stored on this data storage system. Thus, when this description says that a particular logical module performs a particular activity, such a statement may be interpreted to mean that instructions of the logical module, when executed by the processing unit 604, cause the electronic computing device 600 to perform the activity. In other words, when this description says that a particular logical module performs a particular activity, a reader may interpret such a statement to mean that the instructions configure the electronic computing device 600 such that the electronic computing device 600 performs the particular activity.

The techniques of this disclosure may be realized in a wide variety of ways. For example, the techniques of this disclosure may be realized as a method of generating a comparison task list that reports differences between a source task list and a modified task list. The method comprises generating, by a computing system, a comparison task list from a source task list. The source task list comprises a first set of task items. Each task item in the source task list comprises a set of fields that specify values describing aspects of a different task in a planned project of an enterprise. The comparison task list contains a different task item for each task item in the source task list. Each of the task items in the comparison task list comprises a plurality of current value fields and a plurality of previous value fields. The previous value fields of the task items in the comparison task list specify values specified by fields of task items in the source task list. In addition, the method comprises automatically determining, by the computing system, whether there are any unprocessed task items in a modified task list. The modified task list comprises a second set of task items. Each task item in the modified task list comprising a set of fields that specify values describing aspects of a different task in the planned project. Furthermore, the method comprises, while there is an unprocessed task item in the modified task list automatically identifying, by the computing system, a current task item in the modified task list, the current task item being an initial unprocessed task item in the modified task list. The method also comprises automatically determining, by the computing system, whether the current task item has an equivalent task item in the comparison task list. The method also comprises, when the current task item does not have an equivalent task item in the comparison task list automatically determining, by the computing system, whether the current task item is an initial task item in the modified task list. In addition, the method comprises, when the current task item is the initial task item in the modified task list, automatically adding, by the computing system, a new initial task item to the comparison task list. The new initial task item is an initial task item in the comparison task list. For each of the fields of the current task item, the new initial task item has a current value field and a previous value field. The current value fields of the new initial task item specify the values specified by corresponding ones of the fields of the current task item. Furthermore, the method comprises when the current task item is not the initial task item in the modified task list automatically determining, by the computing system, whether the current task item has a previously-processed sibling task item in the modified task list. In addition, the method comprises when the current task item has a previously-processed sibling task item in the modified task list, automatically adding, by the computing system, a new sibling task item to the comparison task list. The new sibling task item follows a task item in the comparison task list that is equivalent to the previously-processed sibling task item. For each of the fields of the current task item, the new sibling task item has a current value field and a previous value field. The current value fields of the new sibling task item specify values specified by corresponding ones of the fields of the current task item. In addition, the method comprises when the current task item does not have a previously-processed sibling task item in the modified task list automatically adding, by the computing system, a new child task item to the comparison task list. The new child task item is an initial child task item of a task item in the comparison task list that is equivalent to the parent task item of the current task item. For each of the fields of the current task item, the new child task item has a current value field and a previous value field. The current value fields of the new child task item specify the values specified by corresponding ones of the fields of the current task item. In addition, the method comprises when there are no unprocessed task items in the modified task list, automatically displaying, by the computing system, the comparison task list on a display device.

In another example, the techniques of this disclosure may be realized as a computing system comprising a processing unit comprising at least one integrated circuit. The computing system also comprises a display device. In addition, the computing system comprises a data storage system comprising at least one computer readable data storage medium. The data storage system stores instructions that, when executed by the processing unit, cause the computing system to generate a comparison task list from a source task list. The source task list comprises a first set of task items. Each task item in the source task list comprises a set of fields that specify values describing aspects of a different task in a planned project of an enterprise. The comparison task list contains a different task item for each task item in the source task list. Each of the task items in the comparison task list comprises a plurality of current value fields and a plurality of previous value fields. The previous value fields of the task items in the comparison task list specify values specified by fields of task items in the source task list. The instructions further cause the computing system to automatically determine whether there are any unprocessed task items in a modified task list. The modified task list comprises a second set of task items. Each task item in the modified task list comprises a set of fields that specify values describing aspects of a different task in the planned project. In addition, while there is an unprocessed task item in the modified task list the instructions cause the computing system to automatically identify a current task item in the modified task list, the current task item being an initial unprocessed task item in the modified task list. In addition, the instructions cause the computing system to automatically determine whether the current task item has an equivalent task item in the comparison task list. When the current task item does not have an equivalent task item in the comparison task list, the instructions cause the computing system to automatically determine whether the current task item is an initial task item in the modified task list. When the current task item is the initial task item in the modified task list, the instructions cause the computing system to automatically add a new initial task item to the comparison task list. The new initial task item is an initial task item in the comparison task list. For each of the fields of the current task item, the new initial task item has a current value field and a previous value field. The current value fields of the new initial task item specify the values specified by corresponding ones of the fields of the current task item. When the current task item is not the initial task item in the modified task list, the instructions cause the computing system to automatically determine whether the current task item has a previously-processed sibling task item in the modified task list. When the current task item has a previously-processed sibling task item in the modified task list, the instructions cause the computing system to automatically add a new sibling task item to the comparison task list. The new sibling task item follows a task item in the comparison task list that is equivalent to the previously-processed sibling task item. For each of the fields of the current task item, the new sibling task item has a current value field and a previous value field. The current value fields of the new sibling task item specify values specified by corresponding ones of the fields of the current task item. When the current task item does not have a previously-processed sibling task item in the modified task list, the instructions cause the computing system to automatically add a new child task item to the comparison task list. The new child task item is an initial child task item of a task item in the comparison task list that is equivalent to the parent task item of the current task item. For each of the fields of the current task item, the new child task item has a current value field and a previous value field. The current value fields of the new child task item specify the values specified by corresponding ones of the fields of the current task item. When there are no unprocessed task items in the modified task list, the instructions cause the computing system to automatically display, on the display device, a table having a row for each task item in the comparison task list and a column for each field of the task items in the comparison task list.

In another example, the techniques of this disclosure may be realized as a computer readable data storage medium storing instructions that, when executed by a processing unit of a computing system, cause the computing system to receive editing input from a user to edit a source task list; the source task list comprising a first set of task items. Each task item in the source task list comprises a set of fields that specify values describing aspects of a different task in a planned project of an enterprise. The instructions also cause the computing system to update, in response to receiving the editing input, the source task list based on the editing input. After updating the source task list based on the editing input but before saving the source task list, the instructions cause the computing system to save the source task list as a modified task list. In addition, the instructions cause the computing system to generate a task item in a comparison task list for each task item in the source task list, each of the task items in the comparison task list comprising a plurality of current value fields and a plurality of previous value fields. The instructions also cause the computing system to copy values specified by each field of the task items in the source task list into corresponding ones of the previous value fields of the task items in the comparison task list. Furthermore, the instructions cause the computing system to automatically determine whether there are any unprocessed task items in the modified task list. While there is an unprocessed task item in the modified task list, the instructions cause the computing system to automatically identify a current task item in the modified task list. The current task item is an initial unprocessed task item in the modified task list. The current task item has a unique identifier field and a creation time field. The unique identifier field contains a unique identifier that is unique among task items in the modified task list. The creation time field specifies a time value that indicates a time and date at which the current task item was created. Furthermore, the instructions cause the computing system to automatically determine whether the current task item has an equivalent task item in the comparison task list by determining that the current task item has an equivalent task item in the comparison task list when the unique identifier field of the current task item specifies a first unique identifier that is the same as a second unique identifier specified by a unique identifier field of the task item in the comparison task list and the creation time field of the current task item specifies a first time value that is the same as a second time value specified by a creation time field of the task item in the comparison task list. When the current task item has an equivalent task item in the comparison task list, the instructions cause the computing system to automatically add values specified by fields of the current task item to corresponding ones of the current value fields of the equivalent task item. Furthermore, when the current task item has an equivalent task item in the comparison task list, the instructions cause the computing system to automatically determine whether the current task item and the equivalent task item contain different field values. When the current task item and the equivalent task item contain different field values, the instructions cause the computing system to automatically add a difference value to a difference field of the equivalent task item. The difference value indicates a difference between a value specified by a field of the current task item and a value specified by a corresponding one of the previous value fields of the equivalent task item. When the current task item does not have an equivalent task item in the comparison task list, the instructions cause the computing system to automatically determine whether the current task item is an initial task item in the modified task list. When the current task item is the initial task item in the modified task list, the instructions cause the computing system to automatically add a new initial task item to the comparison task list. The new initial task item is an initial task item in the comparison task list. For each of the fields of the current task item, the new initial task item has a current value field and a previous value field. The current value fields of the new initial task item specify the values specified by corresponding ones of the fields of the current task item. When the current task item is not the initial task item in the modified task list, the instructions cause the computing system to automatically determine whether the current task item has a previously-processed sibling task item in the modified task list. When the current task item has a previously-processed sibling task item in the modified task list, the instructions cause the computing system to automatically add a new sibling task item to the comparison task list. The new sibling task item follows a task item in the comparison task list that is equivalent to the previously-processed sibling task item. For each of the fields of the current task item, the new sibling task item has a current value field and a previous value field. The current value fields of the new sibling task item specify values specified by corresponding ones of the fields of the current task item. When the current task item does not have a previously-processed sibling task item in the modified task list, the instructions cause the computing system to automatically add a new child task item to the comparison task list. The new child task item is an initial child task item of a task item in the comparison task list that is equivalent to the parent task item of the current task item. For each of the fields of the current task item, the new child task item has a current value field and a previous value field. The current value fields of the new child task item specify the values specified by corresponding ones of the fields of the current task item. When there are no unprocessed task items in the modified task list, the instructions cause the computing system to automatically display, on a display device, a table having a row for each task item in the comparison task list and a column for each field of the task items in the comparison task list.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

We claim:

1. A method of generating a comparison task list that reports differences between a source task list and a modified task list, the method comprising:
generating, by a computing system, a comparison task list from a source task list, the source task list comprising a first set of task items, each task item in the source task list comprising a set of fields that specify values describing aspects of a different task in a planned project of an enterprise, the comparison task list containing a different task item for each task item in the source task list, each of the task items in the comparison task list comprising a plurality of current value fields and a plurality of previous value fields, the previous value fields of the task items in the comparison task list specifying values specified by fields of task items in the source task list;
automatically determining, by the computing system, whether there are any unprocessed task items in a modified task list, the modified task list comprising a second set of task items, each task item in the modified task list comprising a set of fields that specify values describing aspects of a different task in the planned project;
while there is an unprocessed task item in the modified task list:
automatically identifying, by the computing system, a current task item in the modified task list, the current task item being an initial unprocessed task item in the modified task list;
automatically determining, by the computing system, whether the current task item has an equivalent task item in the comparison task list;
when the current task item does not have an equivalent task item in the comparison task list:
automatically determining, by the computing system, whether the current task item is an initial task item in the modified task list;
when the current task item is the initial task item in the modified task list, automatically adding, by the computing system, a new initial task item to the comparison task list; the new initial task item is an initial task item in the comparison task list; for each of the fields of the current task item, the new initial task item has a current value field and a previous value field; the current value fields of the new initial task item specifying the values specified by corresponding ones of the fields of the current task item;
when the current task item is not the initial task item in the modified task list:
automatically determining, by the computing system, whether the current task item has a previously-processed sibling task item in the modified task list;
when the current task item has a previously-processed sibling task item in the modified task list, automatically adding, by the computing system, a new sibling task item to the comparison task list; the new sibling task item follows a task item in the comparison task list that is equivalent to the previously-processed sibling task item; for each of the fields of the current task item, the new sibling task item has a current value field and a previous value field; the current value fields of the new sibling task item specify values specified by corresponding ones of the fields of the current task item; and
when the current task item does not have a previously-processed sibling task item in the modified task list automatically adding, by the computing system, a new child task item to the comparison task list; the new child task item is an initial child task item of a task item in the comparison task list that is equivalent to the parent task item of the current task item; for each of the fields of the current task item, the new child task item has a current value field and a previous value field; the current value fields of the new child task item specify the values specified by corresponding ones of the fields of the current task item; and
when there are no unprocessed task items in the modified task list, automatically displaying, by the computing system, the comparison task list on a display device.

2. The method of claim 1 further comprising:
when the current task item has an equivalent task item in the comparison task list:
automatically adding, by the computing system, values specified by the fields of the current task item to corresponding ones of the current value fields of the equivalent task item;
automatically determining, by the computing system, whether the current task item and the equivalent task item contain different field values; and
when the current task item and the equivalent task item contain different field values, automatically adding, by the computing system, a difference value to a difference field of the equivalent task item, the difference value indicating a difference between a value specified by a field of the current task item and a value specified by a corresponding one of the previous value fields of the equivalent task item.

3. The method of claim 1, wherein automatically displaying the comparison task list comprises automatically displaying, by the computing system, a table having a row for each task item in the comparison task list and a column for each field of the task items in the comparison task list.

4. The method of claim 3, wherein the table includes a status column that includes a status indicator for each task item in the comparison task list, the status indicator for a task item in the comparison task list indicating whether the task item is in both the source task list and the modified task list, whether the task item is in the source task list but not the modified task list, or whether the task item is in the modified task list but not the source task list.

5. The method of claim 3, wherein each task item in the source task list has a task name field indicating a task name of a task, an anticipated start date field indicating a first date when work on the task is expected to begin, and an anticipated end date field indicating a second date when work on the task is expected to be complete.

6. The method of claim 5, wherein each task item in the source task list has a duration field that specifies a duration of time between the first date and the second date.

7. The method of claim 5, wherein automatically displaying the table comprises automatically displaying the table such that, for each task item in the comparison task list, the task name specified by the task name field of a first task item is indented relative to the task name specified by the task name field of a second task item when the first task item is a child of the second task item.

8. The method of claim 3, wherein the table includes expand/collapse controls positioned in the task name fields of each task item having one or more child task items.

9. The method of claim 1,
wherein the current task item has a unique identifier field and a creation time field, the unique identifier field containing a unique identifier that is unique among task items in the modified task list, the creation time field containing a time value that indicates a time and date at which a task item was created; and
wherein automatically determining whether the current task item has an equivalent task item in the comparison task list comprises determining, by the computing system, that the current task item has an equivalent task item in the comparison task list when the unique identifier field of the current task item specifies a first unique identifier that is the same as a second unique identifier specified by the unique identifier field of the task item in the comparison task list and the creation time field of the current task item specifies a first time value that is the same as a second time value specified by the creation time field of the task item in the comparison task list.

10. The method of claim 1, wherein the computing system comprises a data storage system that stores instructions that when executed by a processing unit of the computing system cause the computing system to perform the steps of claim 1, the processing unit comprising one or more integrated circuits.

11. The method of claim 1 further comprising:
receiving, at the computing system, editing input from a user to edit the source task list;
in response to receiving the editing input, updating, by the computing system, the source task list based on the editing input; and
after updating the source task list based on the editing input but before saving the source task list, saving, by the computing system, the source task list as the modified task list.

12. The method of claim 11,
wherein the editing input indicates that the user wishes to add a new task item to the source task list; and
wherein updating the source task list comprises updating the source task list to include the new task item.

13. A computing system comprising:
a processing unit comprising at least one integrated circuit;
a display device; and
a data storage system comprising at least one computer readable data storage medium, the data storage system storing instructions that, when executed by the processing unit, cause the computing system to:
generate a comparison task list from a source task list, the source task list comprising a first set of task items, each task item in the source task list comprising a set of fields that specify values describing aspects of a different task in a planned project of an enterprise, the comparison task list containing a different task item for each task item in the source task list; each of the task items in the comparison task list comprising a plurality of current value fields and a plurality of previous value fields; the previous value fields of the task items in the comparison task list specifying values specified by fields of task items in the source task list;
automatically determine whether there are any unprocessed task items in a modified task list, the modified task list comprising a second set of task items, each task item in the modified task list comprising a set of fields that specify values describing aspects of a different task in the planned project;
while there is an unprocessed task item in the modified task list:
automatically identify a current task item in the modified task list, the current task item being an initial unprocessed task item in the modified task list;
automatically determine whether the current task item has an equivalent task item in the comparison task list;
when the current task item does not have an equivalent task item in the comparison task list:
automatically determine whether the current task item is an initial task item in the modified task list;
when the current task item is the initial task item in the modified task list, automatically add a new initial task item to the comparison task list; the new initial task item is an initial task item in the comparison task list; for each of the fields of the current task item, the new initial task item has a current value field and a previous value field; the current value fields of the new initial task item specifying the values specified by corresponding ones of the fields of the current task item;
when the current task item is not the initial task item in the modified task list:
automatically determine whether the current task item has a previously-processed sibling task item in the modified task list;
when the current task item has a previously-processed sibling task item in the modified task list, automatically add a new sibling task item to the comparison task list; the new sibling task item follows a task item in the comparison task list that is equivalent to the previously-processed sibling task item; for each of the fields of the current task item, the new sibling task item has a current value field and a previous value field; the current value fields of the new sibling task item specify values specified by corresponding ones of the fields of the current task item; and
when the current task item does not have a previously-processed sibling task item in the modified task list, automatically add a new child task item to the comparison task list; the new child task item is an initial child task item of a task item in the comparison task list that is equivalent to the parent task item of the current task item; for each of the fields of the current task item, the new child task item has a current value field and a previous value field; the current value fields of the new child task item specify the values specified by corresponding ones of the fields of the current task item; and
when there are no unprocessed task items in the modified task list, automatically display, on the display device, a table having a row for each task item in the comparison task list and a column for each field of the task items in the comparison task list.

14. The computing system of claim 13, wherein when the current task item has an equivalent task item in the comparison task list the instructions further cause the computing system to:
automatically add values specified by the fields of the current task item to corresponding ones of the current value fields of the equivalent task item;
automatically determine whether the current task item and the equivalent task item contain different field values; and
when the current task item and the equivalent task item contain different field values, automatically add a difference value to a difference field of the equivalent task item, the difference value indicating a difference between a value of a field of the current task item and a corresponding one of the previous value fields of the equivalent task item.

15. The computing system of claim 13, wherein the table includes a status column that includes a status indicator for each task item in the comparison task list, the status indicator for a task item in the comparison task list indicating whether the task item is in both the source task list and the modified task list, whether the task item is in the source task list but not the modified task list, or whether the task item is in the modified task list but not the source task list.

16. The computing system of claim 13, wherein each task item in the source task list has a task name field indicating a task name of a task, an anticipated start date field indicating a first date when work on the task is expected to begin, and an anticipated end date field indicating a second date when work on the task is expected to be complete.

17. The computing system of claim 16, wherein the instructions that cause the computing system to automatically display the table comprise instructions that cause the computing system to automatically display the table such that, for each task item in the comparison task list, the task name specified by the task name field of a first task item is indented relative to the task name specified by the task name field of a second task item when the first task item is a child of the second task item.

18. The computing system of claim 13,
wherein the current task item has a unique identifier field and a creation time field, the unique identifier field containing a unique identifier that is unique among task items in the modified task list, the creation time field containing a time value that indicates a time and date at which a task item was created; and
wherein the instructions that cause the computing system to automatically determine whether the current task item has an equivalent task item in the comparison task list cause the computing system to determine that the current task item has an equivalent task item in the comparison task list when the unique identifier field of the current task item specifies a first unique identifier that is the same as a second unique identifier specified by the unique identifier field of the task item in the comparison task list and the creation time field of the current task item specifies a first time value that is the same as a second time value specified by a creation time field of the task item in the comparison task list.

19. The computing system of claim 13, wherein the instructions further cause the computing system to:
receive editing input from a user to edit the source task list;
in response to receiving the editing input, update the source task list based on the editing input; and
after updating the source task list based on the editing input but before saving the source task list, save the source task list as the modified task list.

20. A computer readable data storage medium storing instructions that, when executed by a processing unit of a computing system, cause the computing system to:
receive editing input from a user to edit a source task list; the source task list comprising a first set of task items; each task item in the source task list comprising a set of fields that specify values describing aspects of a different task in a planned project of an enterprise;
in response to receiving the editing input, update the source task list based on the editing input; and
after updating the source task list based on the editing input but before saving the source task list, save the source task list as a modified task list;
generate a task item in a comparison task list for each task item in the source task list, each of the task items in the comparison task list comprising a plurality of current value fields and a plurality of previous value fields; and
copy values specified by each field of the task items in the source task list into corresponding ones of the previous value fields of the task items in the comparison task list;
automatically determine whether there are any unprocessed task items in the modified task list;
while there is an unprocessed task item in the modified task list:
automatically identify a current task item in the modified task list; the current task item being an initial unprocessed task item in the modified task list; the current task item having a unique identifier field and a creation time field; the unique identifier field containing a unique identifier that is unique among task items in the modified task list; the creation time field specifying a time value that indicates a time and date at which the current task item was created;
automatically determine whether the current task item has an equivalent task item in the comparison task list by determining that the current task item has an equivalent task item in the comparison task list when the unique identifier field of the current task item specifies a first unique identifier that is the same as a second unique identifier specified by a unique identifier field of the task item in the comparison task list and the creation time field of the current task item specifies a first time value that is the same as a second time value specified by a creation time field of the task item in the comparison task list;
when the current task item has an equivalent task item in the comparison task list, the instructions further cause the computing system to:
automatically add values specified by fields of the current task item to corresponding ones of the current value fields of the equivalent task item;
automatically determine whether the current task item and the equivalent task item contain different field values; and
when the current task item and the equivalent task item contain different field values, automatically add a difference value to a difference field of the equivalent task item, the difference value indicating a difference between a value specified by a field of the current task item and a value specified by a corresponding one of the previous value fields of the equivalent task item;
when the current task item does not have an equivalent task item in the comparison task list:
automatically determine whether the current task item is an initial task item in the modified task list;
when the current task item is the initial task item in the modified task list, automatically add a new initial task item to the comparison task list; the new initial task item is an initial task item in the comparison task list; for each of the fields of the current task item, the new initial task item has a current value field and a previous value field; the current value fields of the new initial task item specifying the values specified by corresponding ones of the fields of the current task item;
when the current task item is not the initial task item in the modified task list:
automatically determine whether the current task item has a previously-processed sibling task item in the modified task list;
when the current task item has a previously-processed sibling task item in the modified task list, automatically add a new sibling task item to the comparison task list; the new sibling task item follows a task item in the comparison task list that is equivalent to the previously-processed sibling task item; for each of the fields of the current task item, the new sibling task item has a current value field and a previous value field; the current value fields of the new sibling task item specify values specified by corresponding ones of the fields of the current task item; and
when the current task item does not have a previously-processed sibling task item in the modified task list automatically add a new child task item to the comparison task list; the new child task item is an initial child task item of a task item in the comparison task list that is equivalent to the parent task item of the current task item; for each of the fields of the current task item, the new child task item has a current value field and a previous value field; the current value fields of the new child task item specify the values specified by corresponding ones of the fields of the current task item; and
when there are no unprocessed task items in the modified task list, automatically display, on a display device, a table having a row for each task item in the comparison task list and a column for each field of the task items in the comparison task list.
